(19) United States
(12) Patent Application Publication
(10) Pub. No.: US 2014/0373062 A1
(43) Pub. Date: Dec. 18, 2014

(54) METHOD AND SYSTEM FOR PROVIDING A PERMISSIVE AUXILIARY INFORMATION USER INTERFACE

(71) Applicant: THOMSON LICENSING, Issy deMoulineaux (FR)

(72) Inventor: Jagjeet Singh KHALSA, San Diego, CA (US)

(21) Appl. No.: 13/958,873

(22) Filed: Aug. 5, 2013

Related U.S. Application Data
(60) Provisional application No. 61/836,312, filed on Jun. 18, 2013.

(51) Int. Cl. H04N 21/81; H04N 21/482; H04N 21/43; H04N 21/472

(52) U.S. Cl. CPC H04N 21/8133; H04N 21/47217; H04N 21/482; H04N 21/812; H04N 21/4302
USPC 725/42

(57) ABSTRACT

A method and system are provided. The method and system are for providing a permissive auxiliary information user interface. The method includes receiving a user selection of one or more types of media asset auxiliary information that a user is interested in viewing during a trick mode operation invoked while playing back a media asset. The method further includes storing the user selection in a memory device. The method also includes providing, to the user on a display screen, media asset auxiliary information of the types indicated by the user selection, when the trick mode operation is invoked while playing back the media asset.

### CROSS-REFERENCE TO RELATED APPLICATIONS

This application claims the benefit of U.S. Provisional Application Ser. No. 61/836,312 (Attorney Docket No. PU130081), filed Jun. 18, 2013, which is incorporated by reference herein in its entirety.

### TECHNICAL FIELD

The present principles relate generally to user interfaces and, more particularly, to a method and system for providing a permissive auxiliary information user interface.

### BACKGROUND

An electronic program guide provides a user of a media device with information relating to program content. Banner ads related to a user's profile have been placed in an electronic program guide. However, such banner ads are not always of interest to the user.

### SUMMARY

These and other drawbacks and disadvantages of the prior art are addressed by the present principles, which are directed to a method and system for providing a permissive auxiliary information user interface.

According to an aspect of the present principles, there is provided a method. The method includes receiving a user selection of one or more types of media asset auxiliary information that a user is interested in viewing during a trick mode operation invoked while playing back a media asset. The method further includes storing the user selection in a memory device. The method also includes providing, to the user on a display screen, media asset auxiliary information of the types indicated by the user selection, when the trick mode operation is invoked while playing back the media asset.

According to another aspect of the present principles, there is provided a system. The system includes a media asset auxiliary information manager for receiving a user selection of one or more types of media asset auxiliary information that a user is interested in viewing during a trick mode operation invoked while playing back a media asset. The system further includes a memory device for storing the user selection. The media asset auxiliary information manager provides, to the user on a display screen, media asset auxiliary information of the types indicated by the user selection, when the trick mode operation is invoked while playing back the media asset.

According to yet another aspect of the present principles, there is provided a non-transitory computer readable storage medium having computer executable code stored thereon for performing a method. The method includes receiving a user selection of one or more types of media asset auxiliary information that a user is interested in viewing during a trick mode operation invoked while playing back a media asset. The method also includes providing, to the user on a display screen, media asset auxiliary information of the types indicated by the user selection, when the trick mode operation is invoked while playing back the media asset.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for providing a permissive auxiliary information user interface, in accordance with an embodiment of the present principles;

FIG. 4 shows an exemplary method 400 for providing a permissive auxiliary information user interface, in accordance with an embodiment of the present principles; and

FIG. 5 shows an exemplary user interface 500, in accordance with an embodiment of the present principles.

### DETAILED DESCRIPTION

The present principles are directed to a method and system for providing a permissive auxiliary information user interface.

In an embodiment, a user designates the type(s) of auxiliary information that is shown during a pause operation in the viewing of media. In an embodiment, the user can pre-select the type(s) of auxiliary information, such that the user is shown such information type(s) during a subsequent viewing session(s). In this way, a user can more assuredly see something that actually interests the user, as compared to random information or information estimated (often incorrectly) to be of interest to the user.

In any embodiment, the auxiliary information can include, but is not limited to, an actor biography, a director biography, a producer biography, crew member information, author information relating to an author of the media asset, a review reviews (e.g., by a movie critic, and so forth), a score, information about a production of the media asset, merchandise information relating to a theme of the media asset, and product information relating to one or more products that appear in the media asset. It is to be appreciated that the preceding types of auxiliary information are provided for illustrative purposes and, thus, other types of auxiliary information can also be used. That is, given the teachings of the present principles provided herein, one of ordinary skill in the art will contemplate these and various other types of auxiliary information to which the present principles can be applied, while maintaining the spirit of the present principles.

While one or more embodiments of the present principles are described herein with respect to a pause operation, it is to be appreciated that the present principles can be used with respect to any type of “trick mode” operation including, but not limited to, rewind, fast-forward, and so forth. Thus, for the purposes of the present principles, trick mode is presumed to at least include any of a pause operation, a rewind operation, a fast-forward operation, and so forth. Given the teachings of the present principles provided herein, one of ordinary skill in the art will contemplate these and other applications/scenarios to which the present principles can be applied, while maintaining the spirit of the present principles.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

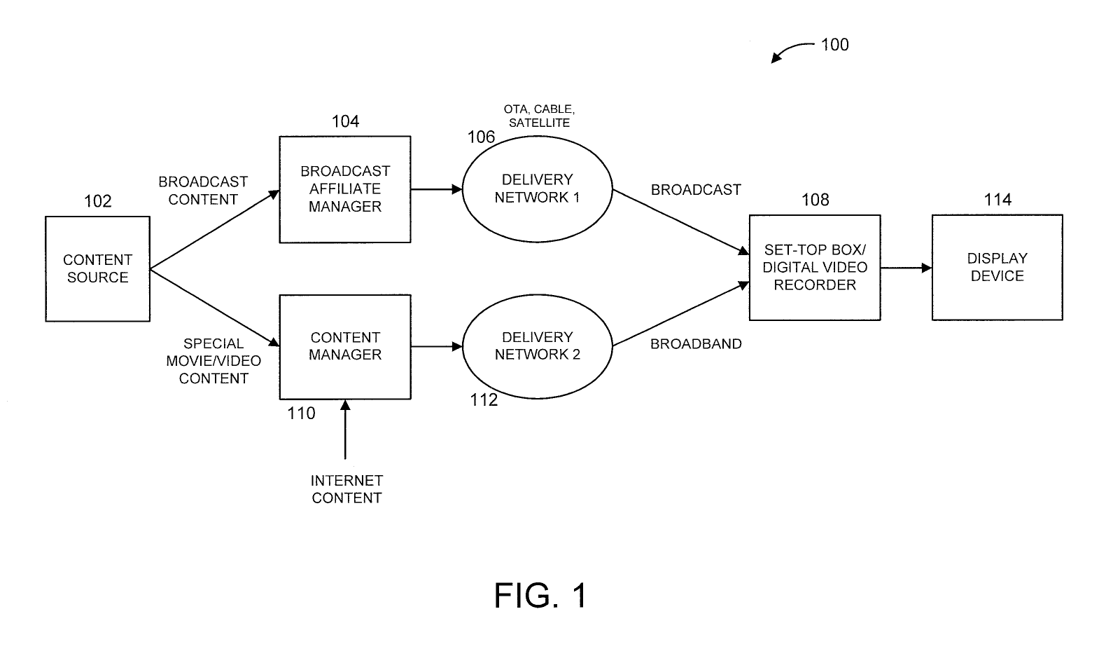

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

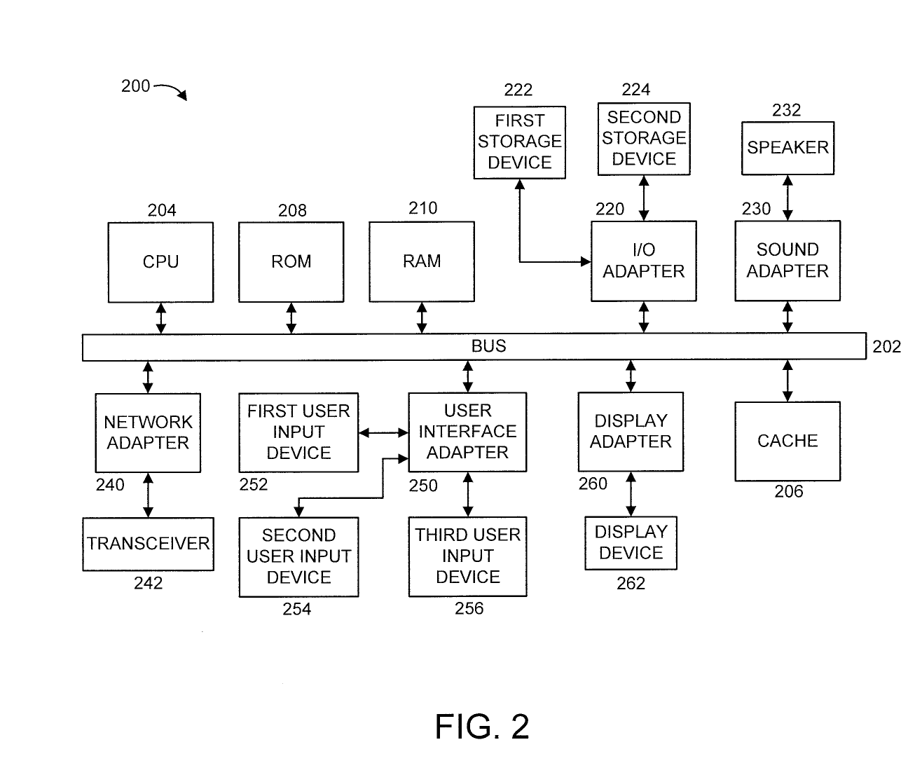

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used.

Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

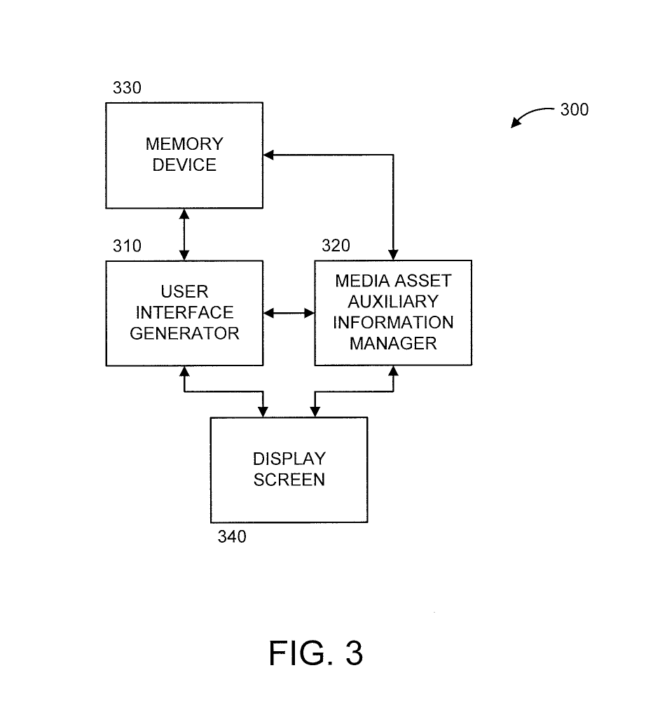

Moreover, it is to be appreciated that system 300 described below with respect to FIG. 3 is a system for implementing respective embodiments of the present principles. Part or all of processing system 200 may be implemented in one or more of the elements of system 300.

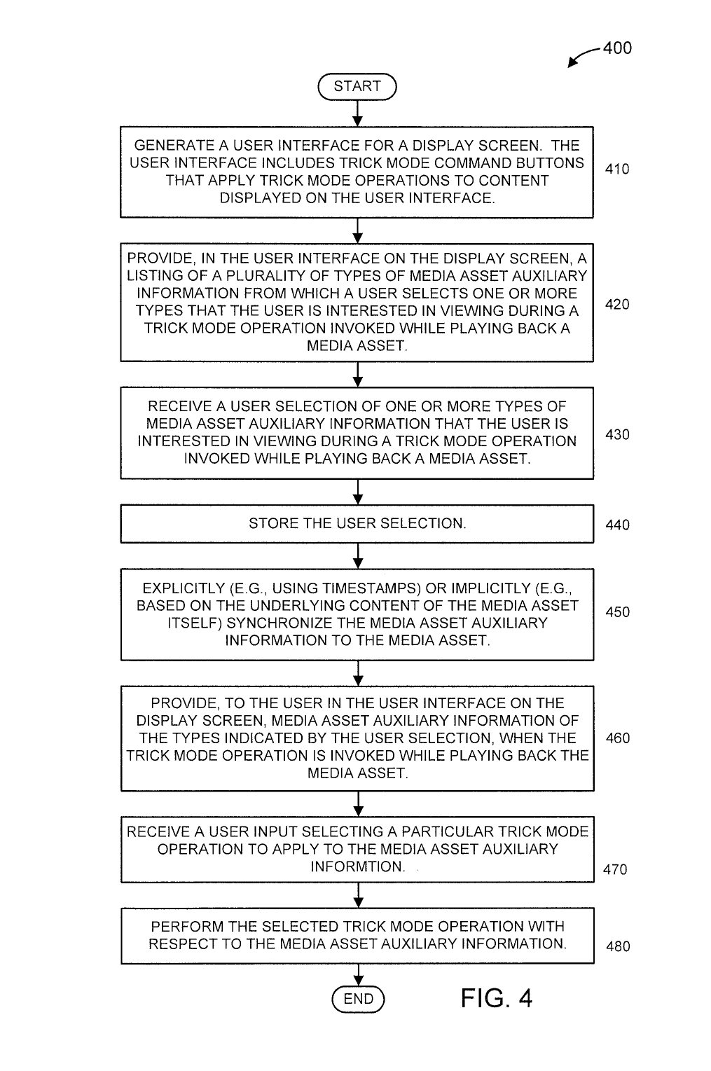

Further, it is to be appreciated that processing system 200 may perform at least part of the method described herein including, for example, at least part of method 400 of FIG. 4. Similarly, part or all of system 300 may be used to perform at least part of method 400 of FIG. 4.

FIG. 3 shows an exemplary system 300 for providing a permissive auxiliary information user interface, in accordance with an embodiment of the present principles. The system 300 includes a user interface generator 310, a media asset auxiliary information manager 320, a memory device 330, and a display screen 340.

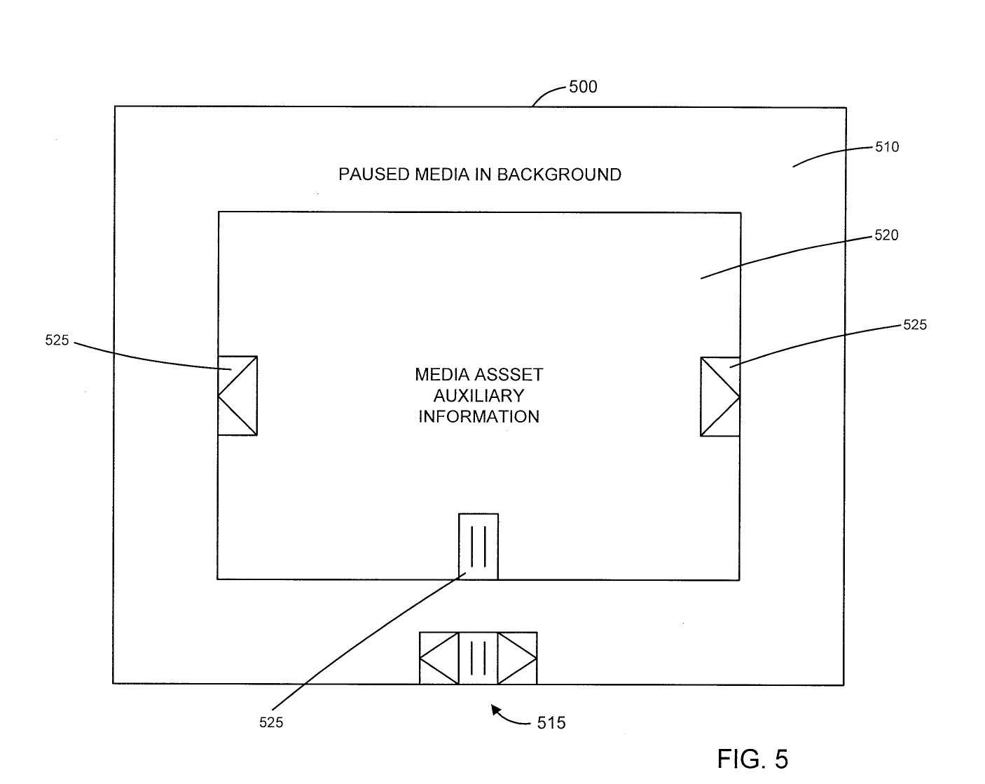

The user interface generator 310 generates a user interface for providing media asset auxiliary information. In an embodiment, the user interface generator 310 configures the user interface to permit the user to perform at least some trick mode operations on the media asset auxiliary information currently displayed on the user interface. In an embodiment, the user interface generator 310 configures the user interface to permit the user to perform at least some trick mode operations on the media asset current displayed on the user interface. An exemplary user interface is shown and described with respect to FIG. 5.

The media asset auxiliary information manager 320 manages the media asset auxiliary information that can be presented (displayed) to a user. In an embodiment, the media asset auxiliary information manager 320 receives a user selection of one or more types of media asset auxiliary information that a user is interested in viewing during a trick mode operation invoked while playing back a media asset. In an embodiment, the media asset auxiliary information manager 320 provides, to the user on the display screen 340, media asset auxiliary information of the types indicated by the user selection, when the trick mode operation is invoked while playing back the media asset.

The memory device 330 stores the user selection. The user selection can be currently used as well as re-used in the future.

The display screen 340 displays the user interface thereon.

While the display screen 340 is shown as part of the system 300 in FIG. 3, in other embodiments the system 300 may simply interact with the display screen 340, which can be part of a different system or device (such as a content consumption or content presentation device). Moreover, in an embodiment, the entirety of system 300 is part of a content consumption or content presentation device. Further, in other embodiments, one or more of the elements of system 300 can be distributed for use by more than one content consumption or content presentation device. Also, in an embodiment, one or more of the elements of system 300 can be part of a gaming device. These and other variations of the elements of FIG. 3 are readily determined by one of ordinary skill in the art, given the teachings of the present principles provided herein, while maintaining the spirit of the present principles.

FIG. 4 shows an exemplary method 400 for providing a permissive auxiliary information user interface, in accordance with an embodiment of the present principles.

At step 410, generate a user interface for a display screen. In an embodiment, the user interface includes trick mode command buttons that apply trick mode operations to content (such as, e.g., the media asset and/or the media asset auxiliary information) displayed on the user interface.

At step 420, provide, in the user interface on the display screen, a listing of a plurality of types of media asset auxiliary information from which a user selects one or more types that the user is interested in viewing during a trick mode operation invoked while playing back a media asset.

At step 430, receive a user selection of one or more types of media asset auxiliary information that the user is interested in viewing during a trick mode operation invoked while playing back a media asset. In the embodiment of FIG. 4, the user selection is provided prior to the playing back of the media asset. In another embodiment, the user selection is provided during the playing back of the media asset. In the latter embodiment, the user selection can still be used during the playing back of (the remainder of) the media asset as well as subsequent playbacks of the media asset.

At step 440, store the user selection.

At step 450, explicitly (e.g., using timestamps) or implicitly (e.g., based on the underlying content of the media asset itself) synchronize the media asset auxiliary information to the media asset.

At step 460, provide, to the user in the user interface on the display screen, media asset auxiliary information of the types indicated by the user selection, when the trick mode operation is invoked while playing back the media asset. In the embodiment of FIG. 4, the media asset auxiliary information provided to the user at step 460 has been synchronized as per step 450, in order to provide the media asset auxiliary information relevant to a current or near current location in the media asset at which the trick mode has been invoked. In another embodiment, the media asset auxiliary information is not synchronized with the corresponding media asset. However, the media asset auxiliary information still corresponds and is relevant to the media asset in the latter case, even if the media asset auxiliary information does not necessarily correspond to a current or near current location in the media asset at which the trick mode has been invoked.

At step 470, receive a user input selecting a particular trick mode operation to apply to the media asset auxiliary information.

At step 480, perform the selected trick mode operation with respect to the media asset auxiliary information.

FIG. 5 shows an exemplary user interface 500, in accordance with an embodiment of the present principles. The user interface 500 includes a background area 510 in which the media asset is shown. The user interface 500 further includes a media asset auxiliary information area 520 in which the media asset auxiliary information is shown. While the background area 510 appears blank in FIG. 5 (as well as the media asset auxiliary information area 520) for the sake of clarity of illustration, it is presumed that a media asset shown in the background area 510 is being currently subjected to a trick mode operation in order for the media asset auxiliary information area 520 to be shown, as the media asset auxiliary information area 520 typically does not appear until a trick mode operation has been invoked for the media asset shown in the background area 510.

Trick mode control buttons 515 are provided on the background area 510 to allow trick mode operations to be controlled with respect to media asset. Trick mode control buttons 525 are also provided on the media asset auxiliary information area 520 to allow trick mode operations to be controlled with respect to the media asset auxiliary information. While buttons have been shown for exemplary purposes, it is to be appreciated that other control mechanisms can also be used to implement the present principles.

For the purposes of the present principles, it is presumed that for a given media asset, there is some auxiliary information that corresponds to the media asset. For example, a media asset can have information corresponding thereto such as, for example, information about each actor starring in the media asset, information about the production of the media asset, merchandise concerning the media asset's theme or products that appear in the media asset (if the media asset is, e.g., a movie), and so forth.

Given the presence of such auxiliary content for a specific media asset, a user specifies the type(s) of auxiliary information they want to see during the playback/pausing of such a media asset. Such a preference then indicates that when a media asset is paused, the user's desired auxiliary content can be shown.

For example, a user indicates before an asset is played back that the user wants to get information about the clothing that the characters wear if the media asset is, e.g., a video. The clothing information could be an auxiliary text track that is time synced to the video using timestamps. For example, in an embodiment, timestamps for the media asset auxiliary information can be generated by the media asset auxiliary information manager 320. Such an approach involving explicit time synchronization is herein referred to as the “explicit synchronization based approach”. Alternatively, information can also be shown based on the media asset itself without any specific time based links. Such an approach lacking explicit time synchronization using timestamps but based on the media asset itself (e.g., the underlying content, e.g., the movie, and so forth) is herein referred to as the “implicit synchronization based approach”.

The implicit synchronization based approach could include things like using voice recognition technology to choose what to display during various trick play states. For example, if during live content a particular location was mentioned, the user could hit pause to bring up a map of the last mentioned location, with that location being determined by the voice recognition technology. Similarly, during a sports game pausing after a player or team was mentioned could bring up information about that player or team. Another implicit approach can involve including GPS coordinates for the film location within the video stream so the user could pause and see the location where the film was filmed.

In an embodiment, the implicit synchronization based approach could even trigger trick play events. For example, there is the well-known State of the Union drinking game where based upon the President saying various key words, players take a drink. In an implicitly synchronized embodiment of this game, the key words could automatically pause the live stream and generate a drink message to the auxiliary interface. Similarly after a goal in sports game, the auxiliary interface could be triggered to pause and play a sound clip (for example, “We are the Champions”).

In an embodiment, when a media asset is paused, details about the products and clothes that appear in a scene of the media asset are shown on the display screen. The information (details, that is, the media asset auxiliary information) can be shown in a user interface, a banner, a window (e.g., a picture-in-picture window, a picture-by-picture window), an overlay, and/or so forth, as readily contemplated by one of ordinary skill in the art, given the teachings of the present principles provided herein. In an embodiment, the information is shown on a user interface overlayed on the underlying media asset currently being displayed and subjected to a trick mode operation. In an embodiment, when a user wants to see “commentary” information about an asset, the asset is paused and text about the particular scene is shown.

Of course, the present principles are not limited to solely the types of auxiliary information. For example, other types of auxiliary information such as, for example, advertisements, actor/director/producer biographies, reviews (e.g., by movie critics and so forth), scores, and so forth. Thus, given the teachings of the present principles provided herein, one of ordinary skill in the art will contemplate these and various other types of auxiliary information relating to a media assert to which the present principles can be applied, while maintaining the spirit of the present principles.

A description will now be given of some of the many attendant advantages/features of the present invention, some of which have been mentioned above. For example, one advantage/feature is a method that includes receiving a user selection of one or more types of media asset auxiliary information that a user is interested in viewing during a trick mode operation invoked while playing back a media asset. The method further includes storing the user selection in a memory device. The method also includes providing, to the user on a display screen, media asset auxiliary information of the types indicated by the user selection, when the trick mode operation is invoked while playing back the media asset.

Another advantage/feature is the method as described above, wherein the user selection is provided prior to playing back the media asset.

Yet another advantage/feature is the method as described above, wherein the media asset auxiliary information includes at least one of an actor biography, a director biography, a producer biography, crew member information, author information, a review, a score, information about a production of the media asset, merchandise information relating to a theme of the media asset, and product information relating to one or more products that appear in the media asset.

Still another advantage/feature is the method as described above, wherein the media asset auxiliary information is explicitly synchronized to the media asset using timestamps.

Moreover, another advantage/feature is the method as described above, wherein the media asset auxiliary information is implicitly synchronized to the media asset based on an underlying content of the media asset.

Further, another advantage/feature is the method wherein the media asset auxiliary information is implicitly synchronized to the media asset based on an underlying content of the media asset as described above, and wherein the media asset auxiliary information comprises a filming location of a currently displayed scene, when the trick mode operation is invoked while playing back the media asset and the trick mode operation is a pause operation.

Also, another advantage/feature is the method as described above, further including providing a listing of a plurality of types of media asset auxiliary information on a user interface on the display screen from which the user selects the one or more types of media asset auxiliary information that the user is interested in viewing during the trick mode operation invoked while playing back the media asset.

Additionally, another advantage/feature is the method as described above, wherein the media asset auxiliary information is provided on a user interface on the display screen, the user interface permitting the user to perform at least some trick mode operations on the media asset auxiliary information currently displayed on the user interface.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
providing for selection by a user at least one type of media asset auxiliary information to be displayed during a trick mode operation of a media asset;
receiving the type of media asset auxiliary information selected by the user;
storing the selected type of media asset auxiliary information in a memory device; and
providing for display media asset auxiliary information corresponding to the selected type of media asset auxiliary information, the media asset auxiliary information provided based on invoking the trick mode operation.

2. The method of claim 1, wherein the user selection is provided prior to invoking the trick mode operation.

3. The method of claim 1, wherein the type of media asset auxiliary information comprises at least one selected from a group of a biography relating to the media asset, crew member information relating to the media asset, a review of the media asset, a score relating to the media asset, information about a production of the media asset, merchandise information relating to a theme of the media asset, and product information relating to at least a product that is displayed in the media asset.

4. The method of claim 1, wherein the media asset auxiliary information is synchronized to the media asset.

5. (canceled)

6. The method of claim 1, wherein the media asset auxiliary information comprises a filming location of a currently displayed scene, and wherein the trick mode operation is a pause operation.

7. The method of claim 1, further comprising providing a listing of a plurality of types of media asset auxiliary information on a user interface on the display screen from which the user selects the one or more types of media asset auxiliary information that the user is interested in viewing during the trick mode operation invoked while playing hack the media asset.

8. The method of claim 1, wherein the media asset auxiliary information is provided on a user interface on the display screen, the user interface permitting the user to perform at least some trick mode operations on the media asset auxiliary information currently displayed on the user interface.

9. A system, comprising:
a media asset auxiliary information manager configured to provide for selection by a user at least one type of media asset auxiliary information to be displayed during a trick mode operation of a media asset and to receive the type of media asset auxiliary information selected by the user; and
a memory device configured to store the selected media asset auxiliary information;
wherein the media asset auxiliary information manager is configured to provide for display media asset auxiliary information corresponding to the selected type of media asset auxiliary information, and
wherein the media asset auxiliary information is provided based on invoking the trick mode operation.

10. The system of claim 9, wherein the system is configured to provide the user selection prior to invoking the trick mode operation.

11. The system of claim 9, wherein the type of media asset auxiliary information comprises at least one selected from a group of a biography relating to the media asset, crew member information relating to the media asset, a review of the media asset, a score relating to the media asset, information about a production of the media asset, merchandise information relating to a theme of the media asset, and product information relating to at least a product that appears in the media asset.

12. The system of claim 9, wherein the media asset auxiliary information is synchronized to the media asset.

13. (canceled)

14. The system of claim 9, wherein the media asset auxiliary information comprises a filming location of a currently displayed scene, and wherein the trick mode operation is a pause operation.

15. The system of claim 9, wherein the media asset auxiliary information manager provides a listing of a plurality of types of media asset auxiliary information on a user interface on the display screen from which the user selects the one or more types of media asset auxiliary information that the user is interested in viewing during the trick mode operation invoked while playing back the media asset.

16. The system of claim 9, further comprising a user interface generator for generating a user interface on the display screen, wherein the media asset auxiliary information is provided on the user interface, the user interface permitting the user to perform at least some trick mode operations on the media asset auxiliary information currently displayed on the user interface.

17. (canceled)

18. A system, comprising:
a media asset auxiliary manager configured to receive a request for at least a type of media asset auxiliary information to be displayed during a trick mode operation of a media asset and to provide of media asset auxiliary information corresponding to the requested type of media asset auxiliary information;
a memory device configured to store the request for the type of media asset auxiliary information,
wherein the type of media asset auxiliary information was selected by a user.

19. The system of claim 18, wherein the type of media asset auxiliary information comprises a filming location of a currently displayed scene, and wherein the trick mode operation is a pause operation.

20. The method of claim 1, wherein the media asset comprises special content.

21. The system of claim 9, wherein the media asset comprises special content.

22. The system of claim 18, wherein the media asset comprises special content.
